(19) United States
(12) Patent Application Publication
(10) Pub. No.: US 2003/0214714 A1
(43) Pub. Date: Nov. 20, 2003

(54) Free-space optical isolator

(76) Inventor: Yu Zheng, Cupertino, CA (US)

Correspondence Address: Bo-In Lin, 13445 Mandoli Drive, Los Altos Hills, CA, 94022, US

(21) Appl. No.: 10/144,954

(22) Filed: May 14, 2002

(51) Int. Cl. G02B 5/30; G02B 27/28; H01S 3/00

(52) U.S. Cl. 359/484; 359/494; 359/495; 359/497; 372/703

(57) ABSTRACT

A new low-cost free-space optical isolator is disclosed in this invention. The new free-space optical isolator includes an input polarizer, a Faraday rotator, an output polarizer, and a magnetic tube. By employing the recently developed subwavelength optical elements (SOEs) technology, the input polarizer is directly manufactured on the left surface of the Faraday rotator and the output polarizer is directly manufactured on the right surface of the Faraday rotator. Relative to the polarization axis of the input polarizer, the polarization axis of the output polarizer is 45 degrees clockwise from left to right.

### FIELD OF THE INVENTION

This invention relates generally to a method and system for making free-space optical isolators for use in optical signal transmission. More particularly, this invention relates to a method and system for providing an improved free-space optical isolator at a low cost.

### BACKGROUND OF THE INVENTION

In optical communications, a free-space optical isolator is commonly employed in an optical laser to prevent any optical signal from entering into the optical laser. FIG. 1 shows the structure of a typical free-space optical isolator 10. The typical optical isolator 10 includes an input polarizer 30, a Faraday rotator 50, an output polarizer 60, and a magnet 80. The magnet 80 is not required when a latching magnetic Faraday rotator is employed. In a typical optical isolator 10, the direction of the magnetic field of the magnet 80 is arranged to direct from the output polarizer 60 to the input polarizer 30. According to a configuration shown in FIG. 1, with the Faraday rotator 50 surrounded by the magnet 80, the polarization rotation angle of the Faraday rotator 50 is along a clockwise direction with a rotation angle of 45 degrees. Relative to the polarization axis 40 of the input polarizer 30, the polarization axis 70 of the output polarizer 60 is 45 degrees clockwise. When a polarized optical signal 10 is projected from the input polarizer 30, the polarization plane of the optical signal 10 is rotated along a clockwise direction by 45 degrees when the optical signal passes through the Faraday rotator 50. Then the optical signal 10 passes through the output polarizer 60. Conversely, as a polarized optical signal 90 is projected from the output polarizer 60, the polarization plane of the optical signal 90 is rotated along a counter-clockwise direction by 45 degrees as the optical signal passes through the Faraday rotator 50. Then the optical signal 90 is prevented from passing through the input polarizer 30 because there is ninety degrees polarization difference between the optical signal 90 and the input polarizer 30. While the typical optical isolator 10 works well for effectively blocking a reverse signal transmission, a conventional isolator as described is limited by its relatively high material costs and time-consuming manufacture processes. Alignment of the input and output polarizers with the Faraday rotators often requires intense and long hours of manual efforts for assembling and fixing these three pieces of optical components. Material costs are increased with the use of separate input and output polarizers 30 and 60. Since the production cost is a most important consideration for broad application of the isolators in an optical fiber signal transmission system, there is a great demand to improve the configuration and manufacture method in order to satisfy such requirement.

Therefore, a need exists in the art of design and manufacture of a free-space optical isolator to overcome the difficulties discussed above. Specifically, an improved free-space optical isolator configuration and manufacturing method with reduced production cost is required.

### SUMMARY OF THE PRESENT INVENTION

It is therefore an object of the present invention to provide a new and improved free-space optical isolator configuration and manufacturing method that can simplify the manufacture processes to significantly reduce the production cost of the free-space optical isolator. This invention discloses a method to simplify the manufacture processes by forming the polarizers directly on the Faraday rotator surface without alignment and assembling processes. The new and improved configuration and manufacturing methods for fabricating the free-space optical isolator can therefore resolve the aforementioned difficulties and limitations in the prior arts.

Specifically, it is an object of the present invention to provide a new free-space optical isolator configuration implemented with a new manufacturing method. Instead of employing two separate input and output polarizers as commonly used in the conventional free-space optical isolator, the two input and output polarizers are directly made on two end-surfaces of the Faraday rotator. The input and output polarizers are formed directly on an input and out end-surfaces by employing a newly developed manufacturing method generally referred to as subwavelength optical elements (SOEs) technology. A “single-piece” polarizer-rotator isolator core is disclosed in the new and improved free-space optical isolator in the present invention. By employing the new and improved free-space optical isolator configuration and manufacturing method of the present invention, time savings are achieved because it is no longer required to spend time on aligning and assembling three pieces of components. Significant cost reductions are also achieved with reduced number of components and production times. With the cost reductions achieved by this invention, the isolators as disclosed can be more practically employed for wide varieties of applications.

Briefly, in a preferred embodiment, the present invention discloses a new low-cost free-space optical isolator. The new free-space optical isolator includes an input polarizer, a Faraday rotator, an output polarizer and a magnet. By employing the subwavelength optical elements (SOEs) technology, the input polarizer is directly manufactured on the left surface of the Faraday rotator and the output polarizer is directly manufactured on the right surface of the Faraday rotator. Relative to the polarization axis of the input polarizer, the polarization axis of the output polarizer is 45 degrees clockwise from left to right.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is schematic diagram showing the structure of a conventional free-space optical isolator;

FIG. 2 is schematic diagram showing the structure of a free-space optical isolator according to the present invention; and

FIG. 3 is surface diagram showing the sub-wavelength patterns formed on the surface by applying the processes based of the SOEs technology.

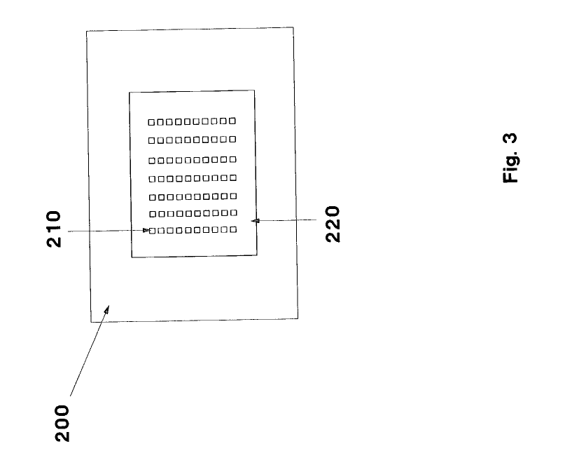

### DETAILED DESCRIPTION OF THE PREFERRED EMBODIMENT

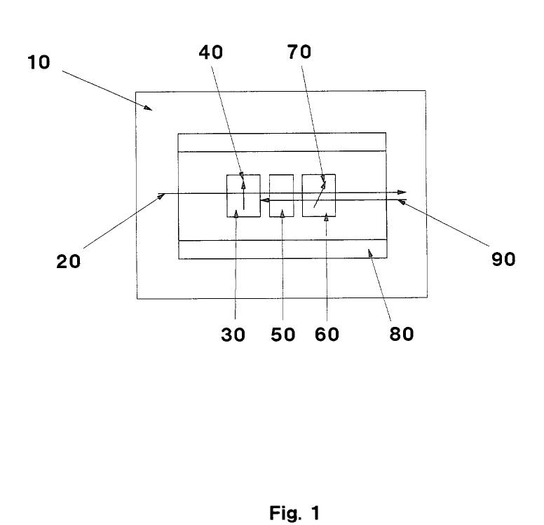

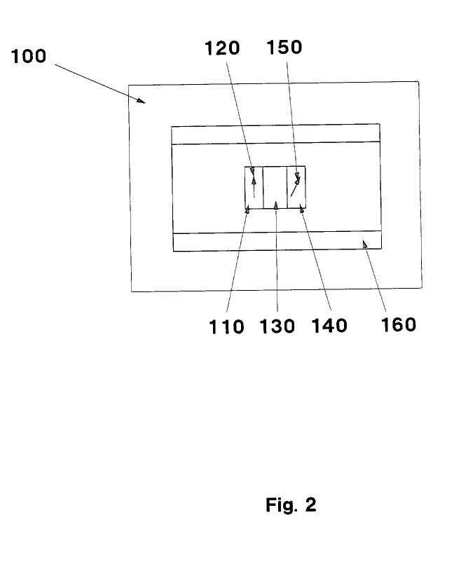

Referring to FIG. 2 for a preferred embodiment of a free-space optical isolator 100 of this invention. The new free-space optical isolator 100 includes an input polarizer 110, a Faraday rotator 130, an output polarizer 140, and a magnet 160. By employing the subwavelength optical elements (SOEs) technology, the input polarizer 110 is directly manufactured on the left surface of the Faraday rotator 130 and the output polarizer 140 is directly manufactured on the right surface of the Faraday rotator 130. Like that in the typical free-space optical isolator as shown in FIG. 1, the magnetic field of the magnetic tube 160 is arranged to direct from the output polarizer 140 to the input polarizer 110. With the magnet 160 surrounds the single-piece polarizer-rotator core unit as shown, the polarization rotation angle of the Faraday rotator 130 is directed to rotate along a clockwise direction of 45 degrees for an optical signal passing through. Also, like that in the typical free-space optical isolator as shown in FIG. 1, relative to the polarization axis 120 of the input polarizer 110, the polarization axis 150 of the output polarizer 140 is 45 degrees clockwise from left to right. When a polarized optical signal is projected from the input polarizer 110 to pass through the Faraday rotator 130, the polarization plane of the optical signal is rotated clockwise by 45 degrees. Then the optical signal passes through the output polarizer 140. Conversely, when a polarized optical signal is projected from the output polarizer 140 along an opposite direction, the polarization plane of the optical signal is rotated counterclockwise by 45 degrees as it passes through the Faraday rotator 130. The optical signal projected along a reverse direction is prevented from passing through the input polarizer 110 because there is a ninety-degree polarization angle difference.

Referring to FIG. 2 for the concept of the SOEs technology. In the SOEs technology, by employing the nano-imprint lithograph technology, a set of subwavelength structures 210 are created on the surface of a substrate 220 to form an optical element with a certain function, like an optical polarizer. Please see the U.S. Pat. No. 5,772,905 for the details of the SOEs technology. Since the SOEs technology is well developed, the input and output polarizers 110 and 140 can be manufactured on surfaces of the Faraday rotator 130 at pretty low cost. Thus, no alignment and assembly between the input and output polarizers 110 and 140 and the Faraday rotator 130 is needed and the production cost of the free-space optical isolator is greatly reduced.

According to above descriptions, this invention discloses a free-space optical isolator. The free-space optical isolator includes a Faraday rotator. The Faraday rotator has an input-end surface and an output-end surface wherein the input-end surface and the output-end surface further includes sub-wavelength patterns constituting an input polarizer and an output polarizer respectively.

In a preferred embodiment, this invention further discloses a method for manufacturing a free-space optical isolator. The method includes a step of forming a set of sub-wavelength patterns constituting an input polarizer on an input end-surface of a Faraday rotator and forming a set of sub-wavelength patterns constituting an output polarizer on an output end surface of the Faraday rotator for transmitting a forward projecting optical signal from the input end-surface to the output end-surface and preventing a reverse transmission of a reverse optical signal from the output end-surface to the input end-surface.

In a preferred embodiment, this invention further discloses a method for manufacturing a free-space optical isolator. The method includes a step of depositing a first layer of non Faraday material on an input end-surface of a Faraday rotator and forming a set of sub-wavelength patterns constituting an input polarizer on said first non Faraday material and depositing a second layer of non Faraday material on an output end surface of the Faraday rotator and forming a set of sub-wavelength patterns constituting an output polarizer on said second non Faraday material for transmitting a forward projecting optical signal from the input end-surface to the output end-surface and preventing a reverse transmission of a reverse optical signal from the output end-surface to the input end-surface.

In summary this invention discloses a free-space optical isolator. The optical isolator includes a polarization angle rotating means. The isolator further includes a first and a second polarizing means each includes sub-wavelength patterns for polarizing, transmitting and receiving an optical transmission to and from the polarization rotating means for allowing an optical transmission only in a forward projecting direction

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A free-space optical isolator comprising:
a Faraday rotator having a first-end surface and a second-end surface wherein at least one of said first-end surface and said second-end surface further comprising sub-wavelength patterns constituting a polarizer.

2. The free-space optical isolator of claim 1 further comprising:
a magnet for providing a magnetic field to said Faraday rotator.

3. The free-space optical isolator of claim 1 wherein:
said Faraday rotator is a latching magnetic Faraday rotator.

4. The free-space optical isolator of claim 1 wherein:
said Faraday rotator is provided for rotating an optical transmission projected from said input polarizer to pass through said output polarizer and for rotating a reverse optical transmission projected from said output polarizer to stop transmission by said input polarizer for isolating said reverse optical transmission.

5. The free-space optical isolator of claim 1 wherein:
said Faraday rotator is provided for rotating an optical transmission projected from said input polarizer to have a substantially same polarization angle with said output polarizer to pass therethrough and for rotating a reverse optical transmission projected from said output polarizer to have a substantially an orthogonal polarization angle relative to said input polarizer for stopping isolating said reverse optical transmission.

6. The free-space optical isolator of claim 1 wherein:
said input polarizer and said output polarizer having substantially a forty-five degrees phase difference and said Faraday rotator rotating a polarized optical transmission projected from said input polarizer to align with a polarization angle of said output polarizer.

7. A free-space optical isolator comprising:
a polarization angle rotating means;
a first and a second polarizing means, wherein at least one of said first and second polarizing means comprising sub-wavelength patterns for polarizing, transmitting and receiving an optical transmission to and from said polarization rotating means for allowing an optical transmission only in a forward projecting direction.

8. The free-space optical isolator of claim 7 wherein:
at least one of said first or second polarizing means is disposed directly on end surfaces of said polarization rotating means.

9. The free-space optical isolator of claim 7 further comprising:
a magnet surrounding said polarization rotating means for effecting a polarization angle rotation of said polarization rotation means.

10. The free-space optical isolator of claim 7 wherein:
said polarization rotation means is a latching magnetic Faraday rotator.

11. A method for manufacturing a free-space optical isolator comprising a step of:
forming a set of sub-wavelength patterns constituting a polarizer on at least one of an input and an output end-surfaces of a Faraday rotator for transmitting a forward projecting optical signal from said input end-surface to said output end-surface and preventing a reverse transmission of a reverse optical signal from said output end-surface to said input end-surface.

12. The method of claim 11 further comprising a step of:
effecting a rotating angle of said Faraday rotator by surrounding a magnet around said Faraday rotator.

13. The free-method of claim 11 wherein:
said step of forming said first polarizer or said second polarizer on said Faraday rotator is a step of forming said polarizers on a latching magnetic Faraday rotator.

14. The method of claim 11 wherein:
said step of forming at least one of said first polarizer and said second polarizer on said Faraday rotator is a step of forming said polarizers on said Faraday rotator for rotating an optical transmission projected from said input polarizer to pass through said output polarizer and for rotating a reverse optical transmission projected from said output polarizer to stop transmission by said input polarizer for isolating said reverse optical transmission.

15. The method of claim 11 wherein:
said step of forming at least one of said first polarizer and said second polarizer on said Faraday rotator is a step of forming said polarizers on said Faraday rotator for rotating an optical transmission projected from said input polarizer to have a substantially same polarization angle with said output polarizer to pass therethrough and for rotating a reverse optical transmission projected from said output polarizer to have a substantially an orthogonal polarization angle relative to said input polarizer for stopping isolating said reverse optical transmission.

16. The method of claim 11 wherein:
said step of forming at least one of said input polarizer and said output polarizer on said Faraday rotator is a step of forming said polarizers having substantially a forty-five degrees phase difference and employing said Faraday rotator to rotate a polarized optical transmission projected from said input polarizer to align with a polarization angle of said output polarizer.

17. A method of manufacturing a free-space optical isolator comprising:
providing a polarization angle rotating means;
forming at least one of a first and a second polarizing means each comprising sub-wavelength patterns for polarizing, transmitting and receiving an optical transmission to and from said polarization rotating means for allowing an optical transmission only in a forward projecting direction.

18. The method of claim 17 wherein:
said step of forming said first and second polarizing means are a step of forming said polarizers directly on end surfaces of said polarization rotating means.

19. The method of claim 17 further comprising:
surrounding said polarization rotating means with a magnet for effecting a polarization angle rotation of an optical transmission pass through said polarization rotation means.

20. The method of claim 17 wherein:
said step of providing a polarization rotation means is a step of providing a latching magnetic Faraday rotator.

21. A free-space optical isolator comprising:
a Faraday rotator having a first-end surface and a second-end surface;
a layer of non Faraday material on at least one of said first- and second-end surfaces wherein said layer of non Faraday material further comprising sub-wavelength patterns constituting a polarizer.

22. The free-space optical isolator of claim 21 further comprising:
a magnet for providing a magnetic field to said Faraday rotator.

23. The free-space optical isolator of claim 21 wherein:
said Faraday rotator is a latching magnetic Faraday rotator.

24. The free-space optical isolator of claim 21 wherein:
said Faraday rotator is a latching magnetic Faraday rotator.

25. The free-space optical isolator of claim 21 wherein:
said first-second-end surfaces of said Faraday rotator further comprising a layer of non Faraday material wherein said layer of non Faraday material further comprising sub-wavelength patterns constituting a polarizer.
